(19) United States
(12) Patent Application Publication
(10) Pub. No.: US 2015/0258525 A1
(43) Pub. Date: Sep. 17, 2015

(54) GRAPHENE-BASED MOLECULAR SIEVES AND METHODS FOR PRODUCTION THEREOF

(71) Applicant: LOCKHEED MARTIN CORPORATION, Bethesda, MD (US)

(72) Inventors: Aaron L. WESTMAN, Brewerton, NY (US); Robert C. MALLORY, Baldwinsville, NY (US)

(21) Appl. No.: 14/656,617

(22) Filed: Mar. 12, 2015

Related U.S. Application Data
(60) Provisional application No. 61/951,947, filed on Mar. 12, 2014.

(51) Int. Cl. B01J 20/20; B01D 29/56; B01J 20/30; B01D 15/08; B01J 20/26; B01J 20/28

(52) U.S. Cl. CPC B01J 20/20; B01J 20/261; B01J 20/262; B01J 20/28042; B01J 20/3007; B01J 20/305; B01D 15/08; B01D 29/56

(57) ABSTRACT

Perforated graphene or perforated graphene-based sheets can be used in forming molecular sieves. The molecular sieves can include a layer of perforated graphene or perforated graphene-based material on a polymer backing. The perforated graphene or graphene-based material and polymer backing can be spiral-wound, for example on a mandrel, to form macrotubes. Methods for producing graphene-based molecular sieves can include growing graphene or graphene-based material on a growth substrate, applying a polymer to the graphene or graphene-based material, removing the growth substrate from the graphene or graphene-based material, perforating the graphene or graphene-based material while it is on the polymer, and winding the perforated graphene or graphene-based material and the polymer into a spiral shape to form a macrotube.

### CROSS-REFERENCE TO RELATED APPLICATIONS

This application claims the benefit of priority under 35 U.S.C. §119 from U.S. Provisional Patent Application 61/951,947, filed Mar. 12, 2014, which is incorporated herein by reference in its entirety.

### STATEMENT REGARDING FEDERALLY SPONSORED RESEARCH OR DEVELOPMENT

Not applicable.

### FIELD

The present disclosure generally relates to separation technology, and, more specifically, to molecular sieves/filters containing graphene or graphene-based materials and methods for production thereof.

### BACKGROUND

Graphene represents an atomically thin layer of carbon in which the carbon atoms reside as closely spaced atoms at regular lattice positions. Synthesizing graphene in a regular lattice is difficult due to the irregular occurrence of defects in as-synthesized two-dimensional materials. Such defects will also be equivalently referred to herein as “apertures,” “perforations,” or “holes.” Apertures can also be introduced intentionally or unintentionally following the synthesis of graphene, including during its removal from a growth substrate and handling thereafter. Aside from such apertures, graphene, graphene-based materials and other two-dimensional materials can represent an impermeable layer to many substances. Therefore, if properly sized, the apertures in the impermeable layer can be useful in conducting selective separation of substances having a particular molecular size from a medium, such as through filtration. The terms “perforated two-dimensional material” or “perforated graphene” will be used herein to denote a sheet of two-dimensional material or graphene with defects in its basal plane, regardless of whether the defects are natively present or intentionally produced. Two-dimensional materials are, most generally, those having atomically thin thickness from single-layer sub-nanometer thickness to a few nanometers and which generally have a high surface area. Two-dimensional materials include metal chalogenides (e.g., transition metal dichalogenides), transition metal oxides, hexagonal boron nitride, graphene, silicene and germanene (see: Xu et al. (2013) “Graphene-like Two-Dimensional Materials) Chemical Reviews 113:3766-3798)

In processes related to filtration, molecular sieves can be used to remove and sequester substances having a particular molecular size from a medium. Molecular sieves and like dessicants can be used, for example, to trap and adsorb small molecules, such as water, within their pores. Illustrative conventional molecular sieve materials can include, for example, zeolites, activated carbon, and silica gel. Although these materials are ubiquitous in everyday life, currently used molecular sieves have limited adsorption capacities totaling roughly 25% of their dry weight. In addition, adsorption rates can be low. Moreover, they offer limited configurability in tuning the effective pore size to remove different molecular sizes from a medium.

In view of the foregoing, production of molecular sieves having higher adsorption capacities and better pore size configurability than those currently in use would be of considerable benefit in the art. The present disclosure satisfies this need and provides related advantages as well.

### SUMMARY

In various embodiments, the present disclosure describes graphene-based molecular sieves/filters. The molecular sieves/filters described herein can include a layer of perforated graphene or graphene-based material on a polymer backing, which can be configured as a spiral-wound structure. Spiral-wound filters are described, for example in U.S. Pat. No. 8,506,807, which is incorporated by reference herein in its entirety.

In some embodiments, voids can exist between the perforated graphene or graphene-based material and the polymer backing, leading to high adsorption capacities. For example, the surface of the polymer backing that supports the graphene or graphene-based material may contain recessed features, such as linear or non-linear channels, that facilitate fluid flow between the graphene or graphene-based material and the polymer backing. A void space exists wherever the graphene or graphene-based material spans a recessed feature of the polymer backing. The recessed features and void spaces may be of any size, so long as the graphene or graphene-based material is sufficiently supported to avoid tearing.

In other various embodiments, the present disclosure describes continuous processes for producing graphene-based molecular sieves. In some embodiments, the methods can include growing graphene on a growth substrate, applying a polymer to the graphene, removing the growth substrate from the graphene, perforating the graphene while it is layered on the polymer, and winding the perforated graphene and polymer on a mandrel.

In an aspect, a molecular sieve or filter comprises a layer of perforated graphene or graphene-based material on a polymer backing.

In an embodiment, the perforated graphene or graphene-based material has an average pore size less than or equal to about 100 nm, less than or equal to about 50 nm, less than or equal to about 20 nm, less than or equal to about 10 nm, less than or equal to about 5 nm, or less than or equal to 1 nm. For example, the perforated graphene or graphene-based material may have an average pore size selected from a range of 0.5 nm to 100 nm, or 0.5 nm to 50 nm, or 0.5 nm to 20 nm, or 0.5 nm to 10 nm, or 0.5 nm to 5 nm. In some embodiments, pores of the perforated two-dimensional materials are chemically functionalized.

In an embodiment, the graphene or graphene-based material has a thickness less than or equal to 20 atomic layers, or less than or equal to 10 atomic layers, or less than or equal to 5 atomic layers, or less than or equal to 2 atomic layers.

In an embodiment, the polymer backing comprises a material selected from the group consisting of poly (methyl methacrylate) (PMMA), polycarbonate, polyester, polyimide, polypropylene, polyvinylidene fluoride and combinations thereof. In an embodiment, the polymer backing is poly (methyl methacrylate) (PMMA). Typically, the polymer backing has a thickness less than or equal to 2000 μm, less than or equal to 1000 μm, less than or equal to 500 μm, or less than or equal to 250 μm. For example, the polymer backing may have a thickness between 10 μm to 2000 μm, between 10 μm to 1000 μm, between 25 μm to 250 μm or between 60 μm to 200 μm.

In the molecular sieves or filters disclosed herein the polymer backing may have a porosity greater than or equal to 10%, or greater than or equal to 20%, or greater than or equal to 30%, or greater than or equal to 40%, or greater than or equal to 50%, or greater than or equal to 55%, or greater than or equal to 60%, or greater than or equal to 65%, or greater than or equal to 75%. For example, the polymer backing may have a porosity between 10% and 75%, or between 10% and 65%, or between 10% and 60%, or between 10% and 50%, or between 10% and 40%, or between 10% and 30%, or between 10% and 20%.

In some embodiments, the polymer backing is hydrophobic or hydrophilic. In some embodiments, the polymer backing is chemically inert to a crude fluid.

In some embodiments, the perforated material and the polymer backing are spiral-wound to form a macrotube. For example, the macrotube may have an outer diameter less than or equal to 2 meters, less than or equal to 0.5 meter, less than or equal to 100 decimeters, less than or equal to 100 centimeters, less than or equal to 100 millimeters, less than or equal to 10 millimeters, or less than or equal to 10 micrometers. Thus, the macrotube may an outer diameter selected from a range of 10 micrometers to 2 meters, or 10 millimeters to 0.5 meters, or 100 millimeters to 100 decimeters, or 100 millimeters to 100 centimeters. Within these given diameters, a spiral-wound macrotube may comprise at least 20 windings/turns, at least 50 windings/turns, at least 100 windings/turns, at least 250 windings/turns, at least 500 windings/turns, at least 1000 windings/turns, at least 5000 windings/turns, or at least 10,000 windings/turns.

In an embodiment, the perforated material and the polymer backing form a planar, multilayer stack, and the multilayer stack may comprise at least 20 layers, at least 50 layers, at least 100 layers, at least 250 layers, at least 500 layers, at least 1000 layers, at least 5000 layers, or at least 10,000 layers.

In some embodiments, the molecular sieve/filter further comprises a void space between the polymer backing and the perforated graphene or graphene-based material.

In an aspect, a method for making a molecular sieve/filter comprises: growing graphene or graphene-based material on a growth substrate; applying a polymer to the graphene or graphene-based material; removing the growth substrate from the graphene or graphene-based material; perforating the graphene or graphene-based material on the polymer; and winding the perforated graphene or graphene-based material and the polymer into a spiral shape to form a macrotube. In an embodiment, the step of perforating the graphene or graphene-based material on the polymer also perforates the polymer. In an alternate embodiment, the step of perforating the graphene or graphene-based material on the polymer does not perforate the polymer.

In an aspect, a method for filtering using a molecular sieve/filter comprises: providing a molecular sieve/filter comprising a layer of perforated graphene or graphene-based material on a polymer backing; winding the perforated graphene or graphene-based material and the polymer into a spiral shape to form a macrotube; and contacting a crude fluid with either an interior or an exterior of the macrotube.

In an embodiment, the crude fluid is an aqueous solution. In this embodiment, water may pass through pores of the perforated graphene or graphene-based material and the polymer backing.

In an embodiment, the crude fluid is an oil-gas mixture.

In an embodiment, the method for filtering using a molecular sieve or filter further comprises a step of applying pressure to the crude fluid, wherein the pressure is selected from a range of 0.5 psi to 2000 psi, or 1 psi to 1000 psi, or 5 psi to 500 psi, or 10 psi to 250 psi, or 50 psi to 250 psi.

In an embodiment, the method for filtering using a molecular sieve or filter further comprises a step of collecting a permeate after it passes from the interior of the macrotube to the exterior of the macrotube. In an alternate embodiment, the method for filtering using a molecular sieve or filter further comprises a step of collecting a permeate after it passes from the exterior of the macrotube to the interior of the macrotube. In either case, the permeate may be water or the permeate may be selected from the group consisting of methane, ethane, propane, butane and combinations thereof.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows an illustrative schematic of a graphene-based molecular sieve or filter of the present disclosure;

FIG. 2 shows an illustrative system and process whereby graphene can be synthesized, liberated from its growth substrate, and configured as a graphene-based molecular sieve or filter; and

FIG. 3 shows an illustrative cross-sectional schematic of a system comprising a graphene-based molecular sieve or filter of the present disclosure.

### DETAILED DESCRIPTION

The present disclosure is directed, in part, to graphene-based molecular sieves and filters. The present disclosure is also directed, in part, to methods for making graphene-based molecular sieves and filters. The present disclosure is also directed, in part, to systems for producing graphene-based molecular sieves and filters. Other two-dimensional materials can be used similarly.

As used herein, the term “molecular sieve” may refer to a porous system that isolates one fluid of a mixture or solution from another fluid of the mixture or solution. In an embodiment, a molecular sieve may isolate the selected fluid by adsorption of the fluid on or in the molecular sieve. In another embodiment, the molecular sieve may isolate the selected fluid by sequestering the fluid within a cavity of the molecular sieve. Sequestration of this type may be considered filtering. Thus, in some embodiments, a molecular sieve may be considered a filter.

Two-dimensional materials include graphene, a graphene-based material, a transition metal dichalcogenide, molybdenum disulfide, a-boron nitride, silicene, germanene, MXenes (e.g., M₂X, M₃X₂, M₄X₃, where M is an early transition metal such as Sc, Ti, V, Zr, Cr, Nb, Mo, Hf and Ta and X is carbon and/or nitrogen) or a combination thereof. Other nanomaterials having an extended two-dimensional, planar molecular structure can also constitute the two-dimensional material in the various embodiments of the present disclosure. For example, molybdenum disulfide is a representative chalcogenide having a two-dimensional molecular structure, and other various chalcogenides can constitute the two-dimensional material in an embodiment of the present disclosure. In another example, two-dimensional boron nitride can constitute the two-dimensional material in an embodiment of the invention. Choice of a suitable two-dimensional material for a particular application can be determined by a number of factors, including the chemical and physical environment into which the graphene, graphene-based or other two-dimensional material is to be deployed.

Graphene-based materials include, but are not limited to, single layer graphene, multilayer graphene or interconnected single or multilayer graphene domains and combinations thereof. In embodiments, multilayer graphene or graphene-based material includes 2 to 20 layers, 2 to 10 layers, or 2 to 5 layers. In embodiments, graphene is the dominant material in a graphene-based material. For example, a graphene-based material comprises at least 30% graphene, or at least 40% graphene, or at least 50% graphene, or at least 60% graphene, or at least 70% graphene, or at least 80% graphene, or at least 90% graphene, or at least 95% graphene. In embodiments, a graphene-based material comprises a range of graphene selected from 30% to 95%, or from 40% to 80%, or from 50% to 70%.

As used herein, a “domain” refers to a region of a material where atoms are uniformly ordered into a crystal lattice. A domain is uniform within its boundaries, but different from a neighboring region. For example, a single crystalline material has a single domain of ordered atoms. In an embodiment, at least some of the graphene domains are nanocrystals, having domain sizes from 1 to 100 nm or 10 to 100 nm. In an embodiment, at least some of the graphene domains have a domain size greater than 100 nm up to 1 micron, or from 200 nm to 800 nm, or from 300 nm to 500 nm. “Grain boundaries” formed by crystallographic defects at edges of each domain differentiate between neighboring crystal lattices. In some embodiments, a first crystal lattice may be rotated relative to a second crystal lattice, by rotation about an axis perpendicular to the plane of a sheet, such that the two lattices differ in “crystal lattice orientation”.

In an embodiment, the sheet of graphene-based material comprises a sheet of single or multilayer graphene or a combination thereof. In an embodiment, the sheet of graphene-based material is a sheet of single or multilayer graphene or a combination thereof. In another embodiment, the sheet of graphene-based material is a sheet comprising a plurality of interconnected single or multilayer graphene domains. In an embodiment, the interconnected domains are covalently bonded together to form the sheet. When the domains in a sheet differ in crystal lattice orientation, the sheet is polycrystalline.

In embodiments, the thickness of the sheet of graphene-based material is from 0.34 to 10 nm, from 0.34 to 5 nm, or from 0.34 to 3 nm. A sheet of graphene-based material may comprise intrinsic defects. Intrinsic defects are those defects resulting unintentionally from preparation of the graphene-based material in contrast to perforations which are selectively introduced into a sheet of graphene-based material or a sheet of graphene. Such intrinsic defects include, but are not limited to, lattice anomalies, pores, tears, cracks or wrinkles. Lattice anomalies can include, but are not limited to, carbon rings with other than 6 members (e.g. 5, 7 or 9 membered rings), vacancies, interstitial defects (including incorporation of non-carbon atoms in the lattice), and grain boundaries.

In an embodiment, the layer comprising the sheet of graphene-based material further comprises non-graphenic carbon-based material located on the surface of the sheet of graphene-based material. In an embodiment, the non-graphenic carbon-based material does not possess long-range order and may be classified as amorphous. In embodiments, the non-graphenic carbon-based material further comprises elements other than carbon and/or hydrocarbons. Non-carbon materials which may be incorporated in the non-graphenic carbon-based material include, but are not limited to, hydrogen, hydrocarbons, oxygen, silicon, copper and iron. In embodiments, carbon is the dominant material in non-graphenic carbon-based material. For example, a non-graphenic carbon-based material comprises at least 30% carbon, or at least 40% carbon, or at least 50% carbon, or at least 60% carbon, or at least 70% carbon, or at least 80% carbon, or at least 90% carbon, or at least 95% carbon. In embodiments, a non-graphenic carbon-based material comprises a range of carbon selected from 30% to 95%, or from 40% to 80%, or from 50% to 70%.

In contrast to conventional molecular sieves, which are often formed from inorganic materials, graphene-based molecular sieves can offer significantly higher adsorption capacities. Although a number of molecular sieve configurations are possible, a spiral-wound macrotube shape provides a number of advantages, as discussed hereinafter.

According to various embodiments of the present disclosure, a sheet of perforated graphene or graphene-based material can be incorporated on a polymer backing and rolled around a mandrel or like structure into a spiral-wound macrotube shape.

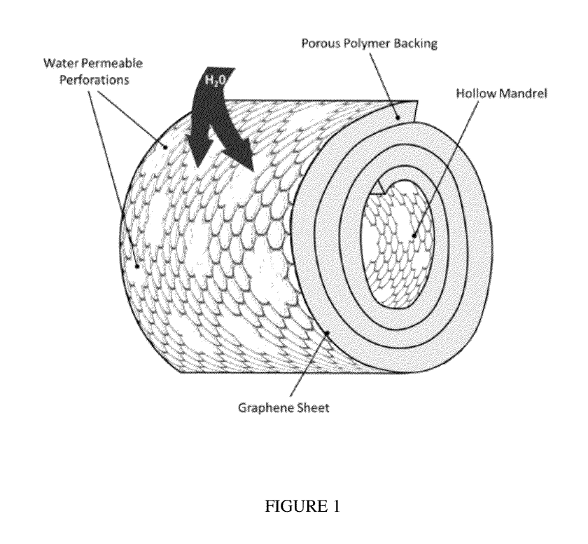

FIG. 1 shows an illustrative schematic of a graphene-based molecular sieve or filter of the present disclosure. Advantages of the macrotube structure include a high density of graphene per unit volume and a substantial exposed surface area. Moreover, such a macrotube shape can be easily fabricated, as discussed hereinafter.

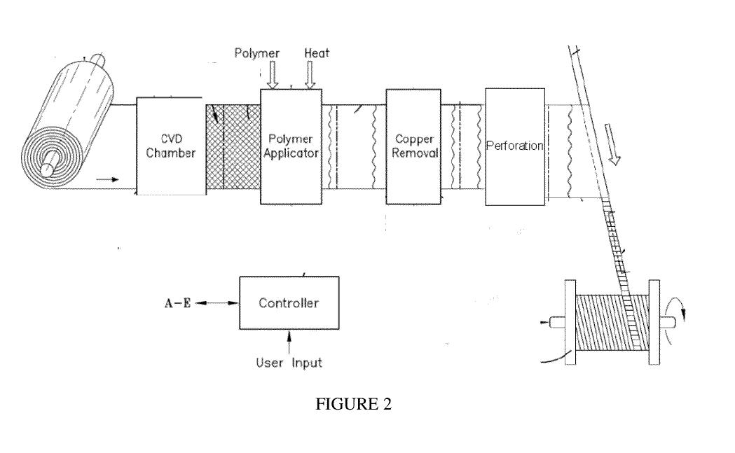

Advantageously, the spiral-wound graphene-based molecular sieves or filters of the present disclosure can be produced by a continuous process. Moreover, such processes are believed to be readily coupled with conventional processes for synthesizing graphene or graphene-based material (e.g., CVD) and for perforating graphene or graphene-based material (e.g., plasma exposure, particle beam exposure, and the like). FIG. 2 shows an illustrative system and process whereby graphene or graphene-based material can be synthesized, liberated from its growth substrate, and configured as a graphene-based molecular sieve or filter. As shown in FIG. 2, graphene or graphene-based material can be grown on a substrate (e.g., a copper substrate) in a continuous process in a CVD chamber and a polymer can subsequently be applied thereto. Thereafter, the growth substrate can be removed, followed by perforation of the graphene or graphene-based material via a suitable technique. The number of perforations and their sizes can be regulated by choice of the conditions under which the perforations are produced, thereby providing access to molecular sieves or filters that have tunable adsorption properties for molecules having different sizes. Finally, the perforated graphene or graphene-based material on the polymer substrate can be wound upon a mandrel to produce the spiral-wound molecular sieves or filters described and depicted herein. The system shown in FIG. 2 can advantageously support high production volumes and provide substantially uniform material thicknesses. Moreover, the harvested macrotube can be cut to various desired lengths based on its intended application.

The technique used for forming the graphene or graphene-based material in the embodiments described herein is not believed to be particularly limited. For example, in some embodiments CVD graphene or graphene-based material can be used. In various embodiments, the CVD graphene or graphene-based material can be liberated from its growth substrate (e.g., Cu) and transferred to a polymer backing. Likewise, the techniques for introducing perforations to the graphene or graphene-based material are also not believed to be particularly limited, other than being chosen to produce perforations within a desired size range. Illustrative perforation techniques can include plasma treatment and particle bombardment. As discussed above, the ability to vary perforation conditions yields tunable molecular sieves/filters.

Perforations are sized to provide desired selective permeability of a species (molecule, ion, etc.) for a given application. Selective permeability relates to the propensity of a porous material or a perforated two-dimensional material to allow passage (or transport) of one or more species more readily or faster than other species. Selective permeability allows separation of species which exhibit different passage or transport rates. In two-dimensional materials, selective permeability correlates to the dimension or size (e.g., diameter) of apertures and the relative effective size of the species. Selective permeability of the perforations in two-dimensional materials, such as graphene-based materials, can also depend on functionalization of perforations (if any) and the specific species that are to be separated. Separation of two species in a mixture includes a change in the ratio (weight or molar ratio) of the two species in the mixture after passage of the mixture through a perforated two-dimensional material.

For example, in applications for separation of water from other species, the molecular diameter of water is about 2.9 Å, as determined from interpolation of the effective ionic radii of isoelectric ions from crystal data, and the mean van der Waals diameter of water, which accounts for electron distribution, is approximately 2.8-3.2 Å. Perforations dimensioned to be about 2.8 angstroms or more should exhibit permeability to water and permeability to water should increase with perforation dimension. The range of perforation size employed depends upon other species present in the medium from which water is to be removed. In specific embodiments, perforations are dimensioned to range between about 2.5 to 5 angstroms. In other embodiments, perforations are dimensioned to range between about 3 to 5 angstroms. In other embodiments, perforations are dimensioned to range between about 3 to 10 angstroms. In other embodiments, perforations are dimensioned to range from 5 to 20 angstroms. It will be appreciated that perforations can be otherwise dimensioned dependent upon the species that are present in the medium from which water is to be removed. Perforations of a selected size can have a 1-10% deviation or a 1-20% deviation from the selected size For circular holes, the characteristic dimension is the diameter of the hole. In embodiments relevant to non-circular pores, the characteristic dimension can be taken as the largest distance spanning the hole, the smallest distance spanning the hole, the average of the largest and smallest distance spanning the hole, or an equivalent diameter based on the in-plane area of the pore. As used herein, perforated graphene-based materials include materials in which non-carbon atoms have been incorporated at the edges of the pores.

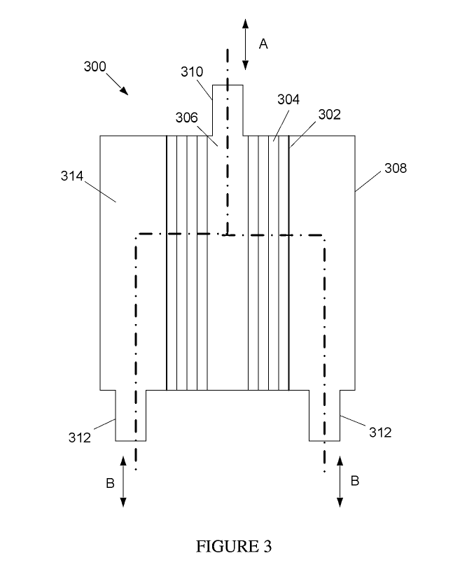

FIG. 3 shows an illustrative cross-sectional schematic of a system 300 comprising a graphene-based molecular sieve/filters 302 comprising perforated graphene or graphene-based material on a polymer backing wound into a spiral configuration to form layers or turns 304 and a hollow channel 306. Graphene-based molecular sieve/filter 302 is disposed in a housing 308 having a first opening 310, one or more second openings 312 and fluid channels 314. In an embodiment, during use, a crude fluid enters first opening 310 into hollow channel 306. Selected species within the crude fluid then pass through molecular sieve/filter 302 into fluid channels 314 (as shown by the dashed line) and out of filter housing 308 through second openings 312. In an alternate embodiment, during use, a crude fluid enters one or more second openings 312 into fluid channels 314. Selected species within the crude fluid then pass through molecular sieve/filter 302 into hollow channel 306 and out of filter housing 308 through first opening 310. Arrows A and B emphasize the bidirectional fluid flow configuration of system 300. Those of skill in the art will appreciate that system 300 may include a plurality of molecular sieves/filters 302 within a filter housing 308, where each molecular sieve/filter 302 has a first opening aligned with its hollow channel 306 and second openings 312 that may be shared amongst molecular sieves/filters 302. In another embodiment, systems 300 may be stacked such that output from one filter housing becomes the input for a subsequent filter housing.

The graphene-based molecular sieves/filters described herein are believed to be advantageous compared to existing molecular sieves/filters due to their ability to adsorb or sequester much higher quantities of a substance per unit weight. Without being bound by theory or mechanism, the high adsorption capacities of the present graphene-based molecular sieves/filters are believed to be due to the relative thinness of the graphene sheet and the void space existing between the graphene sheet and its supporting polymer. In this regard, it is believed that the void space between the graphene or graphene-based sheets can store large amounts of an adsorbed substance once it has passed through the perforations in the graphene or graphene-based material. If desired, the efficiency of the graphene-based molecular sieves/filters can be further tailored by adjusting the thickness and permeability of the polymer backing. In this respect, the polymer backing used in the present embodiments is not believed to be particularly limited.

Although the description herein is primarily directed to graphene and graphene-based materials, it is to be recognized that other two-dimensional materials can be treated in a like manner. That is, molecular sieves/filters formulated using other types of perforated two-dimensional materials can be formed substantially as described herein.

Applications of the graphene-based molecular sieves/filters described herein are not believed to be particularly limited. In some embodiments, the molecular sieves/filters can be used for removing water from a substance. Other substances can be removed as well by tailoring the perforation size of the graphene or graphene-based material. In illustrative embodiments, the graphene-based molecular sieves described herein can be used in oil and gas applications, as well as other applications in which conventional molecular sieves/filters are used.

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomer and enantiomer of the compound described individually or in any combination. One of ordinary skill in the art will appreciate that methods, device elements, starting materials and synthetic methods other than those specifically exemplified can be employed in the practice of the invention without resort to undue experimentation. All art-known functional equivalents, of any such methods, device elements, starting materials and synthetic methods are intended to be included in this invention.

Whenever a range is given in the specification, for example, a temperature range, a time range, or a composition range, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations, which are not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claims.

What is claimed is the following:

1. A molecular sieve/filter comprising:
a layer of perforated graphene or graphene-based material on a polymer backing.

2. The molecular sieve/filter of claim 1, wherein the perforated graphene or graphene-based material has an average pore size less than or equal to 10 nm.

3. The molecular sieve/filter of claim 1, wherein the perforated graphene or graphene-based material has an average pore size selected from a range of 0.5 nm to 10 nm.

4. The molecular sieve/filter of claim 1, wherein pores of the perforated graphene or graphene-based material are chemically functionalized.

5. The molecular sieve/filter of claim 1, wherein the perforated graphene or graphene-based material has a thickness less than or equal to 20 atomic layers.

6. The molecular sieve/filter of claim 1, wherein the polymer backing comprises a material selected from the group consisting of poly (methyl methacrylate) (PMMA), polycarbonate, polyester, polyimide, polypropylene, polyvinylidene fluoride and combinations thereof.

7. The molecular sieve/filter of claim 1, wherein the polymer backing has a thickness less than or equal to 250 μm.

8. The molecular sieve/filter of claim 1, wherein the polymer backing has a thickness between 25 μm to 250 μm.

9. The molecular sieve/filter of claim 1, wherein the polymer backing has a porosity greater than or equal to 10%.

10. The molecular sieve/filter of claim 1, wherein the polymer backing has a porosity between 10% and 50%.

11. The molecular sieve/filter of claim 1 further comprising a void space between the polymer backing and the perforated graphene or graphene-based material.

12. The molecular sieve/filter of claim 1, wherein the perforated material and the polymer backing are spiral-wound to form a macrotube.

13. The molecular sieve/filter of claim 1, wherein the perforated material and the polymer backing form a planar, multilayer stack.

14. A method for making a molecular sieve/filter comprising:
growing graphene or graphene-based material on a growth substrate;
applying a polymer to the graphene or graphene-based material;
removing the growth substrate from the graphene or graphene-based material;
perforating the graphene or graphene-based material on the polymer; and
winding the perforated graphene or graphene-based material and the polymer into a spiral shape to form a macrotube.

15. The method of claim 14, wherein the step of perforating the graphene or graphene-based material on the polymer also perforates the polymer.

16. The method of claim 14, wherein the step of perforating the graphene or graphene-based material on the polymer does not perforate the polymer.

17. A method for filtering using a molecular sieve/filter comprising:
providing a molecular sieve comprising a layer of perforated graphene or graphene-based material on a polymer backing;
winding the perforated graphene or graphene-based material and the polymer into a spiral shape to form a macrotube; and
contacting a crude fluid with either an interior or an exterior of the macrotube.

18. The method of claim 17, wherein the crude fluid is an aqueous solution.

19. The method of claim 18, wherein water passes through pores of the perforated graphene or graphene-based material and the polymer backing.

20. The method of claim 17, wherein the crude fluid is an oil-gas mixture.

21. The method of claim 17 further comprising a step of applying pressure to the crude fluid, wherein the pressure is selected from a range of 0.5 psi to 2000 psi.

22. The method of claim 17 further comprising a step of collecting a permeate after it passes from the interior of the macrotube to the exterior of the macrotube.

23. The method of claim 22, wherein the permeate is water.

24. The method of claim 22, wherein the permeate is selected from the group consisting of methane, ethane, propane, butane and combinations thereof.

25. The method of claim 19 further comprising a step of collecting a permeate after it passes from the exterior of the macrotube to the interior of the macrotube.

26. The method of claim 25, wherein the permeate is water.

27. The method of claim 25, wherein the permeate is selected from the group consisting of methane, ethane, propane, butane and combinations thereof.
